(19) United States
(12) Patent Application Publication
(10) Pub. No.: US 2005/0071812 A1
(43) Pub. Date: Mar. 31, 2005

(54) Combined emulation and simulation debugging techniques

(75) Inventors: Peramachanahalli S. Ramkumar, Bangalore (IN); Vidya Sagar B. Zakkula, Bangalore (IN); Nagaraju N. Kodalapura, Bangalore (IN); Bharathi Anjeneya, Bangalore (IN)

Correspondence Address: SCHWEGMAN, LUNDBERG, WOESSNER & KLUTH, P.A., P.O. BOX 2938, MINNEAPOLIS, MN, 55402, US

(73) Assignee: Intel Corporation

(21) Appl. No.: 10/676,141

(22) Filed: Sep. 30, 2003

(51) Int. Cl. G06F 9/44

(52) U.S. Cl. 717/124

(57) ABSTRACT

Methods, systems, and apparatus combine simulation and emulation debugging in a single debugging session. A debugging session is established to debug instructions. During that session a number of the instructions can be processed in a simulation mode or an emulation mode. Processing can be switched between the modes during the session. Coherency is maintained between both modes of operation during the session.

### TECHNICAL FIELD

Embodiments of the present invention relate generally to data processing, and more particularly to debugging techniques for integrating emulation and simulation during a debugging session.

### BACKGROUND INFORMATION

Modern day chip architectures are extremely powerful. For example, today's chip architectures can include a multitude of embedded system processor architectures. Unfortunately, these powerful chip architectures have also increased the instruction logic density which resides within these chip architectures. As a result, the complexity of instruction logic has increased in order to take advantage of these powerful chip architectures. This has presented a problem for firmware and software development. In particular, the complexity of instruction logic has increased the development time required to debug firmware and software instructions.

Conventionally, there are two modes associated with debugging instruction logic, an emulation mode and a simulation mode. With emulation, a device's chip architecture often includes an emulator for emulating the device's processor architecture. The emulator includes firmware for processing instructions and for interactively debugging the instructions. Emulation uses physical resources of the processor's architecture (e.g., bus, processor, memory) to process instructions in order to produce real or actual results based on utilizing those physical resources. Emulators are good for achieving efficient processing throughput. In other words, emulators can process instructions quickly and with little latency. However, emulators are intentionally designed to include only a small subset of debugging functionality, because on-processor emulation should be resource efficient and should not be unduly complex.

Conversely, with simulation the functionality of a processor's physical resources is abstracted into logical resources represented by software. Thus, instructions in a simulation mode are processed to produce artificial results based on the functionality embodied in those logical resources. This abstraction has advantages and disadvantages. Advantages include being able to efficiently debug non-native instructions (non-native to the processor's architecture), to visualize states of the various resources during the debug, to utilize a robust set of extended debugging utilities not typically available with emulators, and to debug at multiple layers of abstraction. However, the disadvantage of using a simulator is that processing throughput can be substantially slower than what would be experienced with an emulator, because the simulator abstracts or mimics physical resources whereas the emulator directly access those physical resources.

Conventionally, a developer makes a choice to debug with an emulator or a simulator based on the developer's knowledge of the instructions. Once that decision is made and a debugging session is established for the instructions, the developer cannot switch to a different debugging mode in an automated fashion. That is, if the developer begins debugging instructions with an emulator and reaches a point in the instruction logic that would be more efficiently manipulated and inspected with a simulator, then the developer must terminate the current emulation session, note the proper portion of the instruction logic that is needed with a simulator session, start a new simulator session with a simulator, and wait for the simulation session to reach the desired portion of instruction logic that the developer wants to more completely inspect. This is time inefficient, increases the development time associated with debugging instructions, and can increase the likelihood that the developer may miss problem areas within the instruction logic during debugging.

Therefore, there is a need for combining the features of emulation and simulation within a single debugging session in an automated fashion.

### BRIEF DESCRIPTION OF THE DRAWINGS

FIG. 1 is a flow diagram of a method to debug instructions in accordance with one embodiment of the invention.

FIG. 2 is a flow diagram of another method to debug instructions in accordance with one embodiment of the invention.

FIG. 3 is a diagram of a debugging system in accordance with one embodiment of the invention.

FIG. 4 is a diagram of a debugging apparatus in accordance with one embodiment of the invention.

### DESCRIPTION OF THE EMBODIMENTS

Novel methods, systems, and apparatus for debugging instructions are described. In the following detailed description of the embodiments, reference is made to the accompanying drawings, which form a part hereof, and in which are shown by way of illustration, but not limitation, specific embodiments of the invention. These embodiments are described in sufficient detail to enable one of ordinary skill in the art to understand and implement them. Other embodiments may be utilized; and structural, logical, and electrical changes may be made without departing from the spirit and scope of the present disclosure. The following detailed description is, therefore, not to be taken in a limiting sense, and the scope of the embodiments of the inventions disclosed herein is defined only by the appended claims.

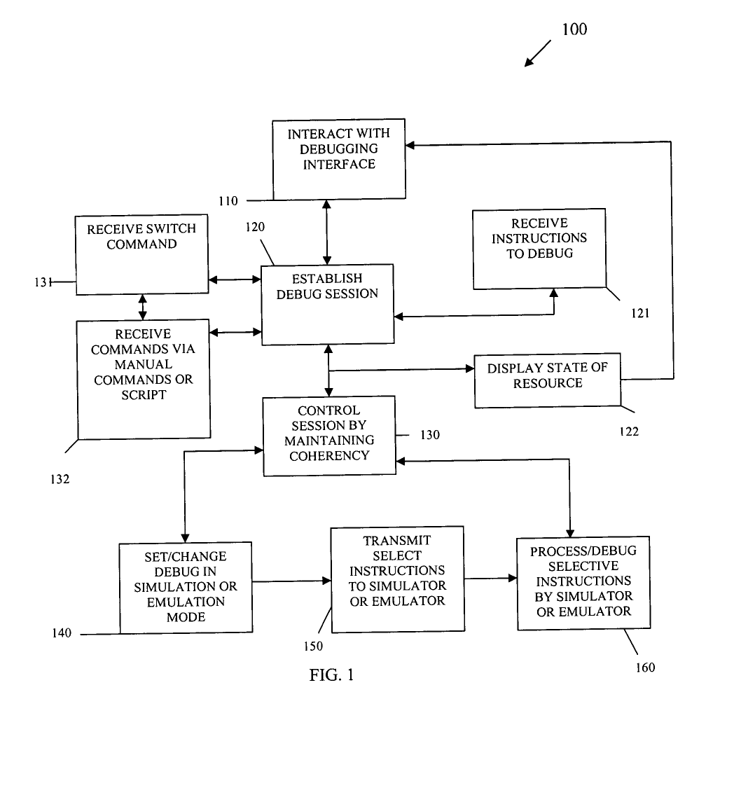

FIG. 1 is a flow chart of a method 100 to debug instructions. The method 100 is implemented in a computer-accessible medium as one or more software applications. The method 100 need not be executing in a computer-accessible medium; however, when the method 100 is executed instructions can be debugged in a novel fashion, according to the processing described below and in other embodiments of the invention.

Initially, instructions are identified for debugging. These instructions are associated with a firmware or software application. Firmware instructions are typically embedded in Read Only Memory (ROM) of a processing device. Software instructions can include firmware instructions and are typically associated with statements that can be processed by a processing device in order to perform operations against resources of the processing device. Generally, a developer determines that a specific set of instructions should be debugged. The determination can be based on normal procedures associated with instruction development or the determination can be based on performance or failure conditions associated with the instructions.

While debugging, the developer selects the instructions, sets the environment for debugging, inputs data values needed by a number of the instructions, inspects states and values of resources being accessed by executing instructions, monitors performance and quality of executing instructions, and the like. Based on the instructions being debugged, the developer may elect to initially use an emulator to begin debugging or may elect to initially use a simulator. This initial choice is based on the instructions being analyzed, the known features of the emulator and simulator, and the known performance characteristics of the emulator and simulator.

Before actually initiating a debugging session which will begin the debugging process, the developer accesses a debugging interface. This debugging interface provides tools, commands, and operations to the developer for interfacing with an existing emulator and an existing simulator. Thus, the debugging interface incorporates and presents an existing interface associated with an existing emulator and an existing interface associated with an existing simulator. Moreover, the debugging interface can modify or augment the views presented by existing interfaces associated with both an existing simulator and an existing emulator. In one embodiment, the debugging interface is a modified version of an existing simulator interface that includes capabilities for integrating an existing emulator's interface. The debugging interface can be graphical, command driven, or a combination of graphical and command driven. Furthermore, the debugging interface also include its own unique features described herein and below.

The debugging interface also interacts with the processing of the method 100 for initiating a debugging session and for providing instructions that are to be debugged, as depicted at 110. At 120, this initial interaction between the debugging interface and the processing of the method 100 establishes a debugging session for debugging the instructions. During the initial interaction, the debugging interface also indicates a number of environmental and data attributes that are set for the debugging session. These attributes were previously provided to the debugging interface by the developer. However, in some embodiments, the debugging interface acquires these attributes from the developer after the debugging session is established with the processing of the method 100.

Attributes can include a variety of configuration data associated with the debugging session. For example, some attributes can define stop points within the instructions where debugging is to stop at specified instructions. Debugging continues after manual confirmation is received from the developer through the debugging interface. At these stop points, the developer can provide via the debugging interface data values for physical and logical resources before debugging continues. Attributes can also alter processing branch points that were originally defined in the instructions. A variety of other attributes associated with debugging interfaces are well known to one of ordinary skill in the art. All of these attributes can be set and defined within the debugging interface and communicated to the processing of the method 100 for purposes of initializing the debugging session.

The instructions to be debugged are loaded for processing into memory of a device implementing the method 100, once the debugging session is established, or while the debugging session is being established. The instructions identify a variety of resources required by the device to process the instructions within an emulator where the needed resources are the physical resources of the device (e.g., processor, memory, bus) and within a simulator the needed resources will be logical (e.g., abstracted functions that mimic the physical resources). The mappings between physical resources that correspond to logical resources are maintained within the processing of the method 100 during the debugging session. In this way, the states and values associated with these resources can be presented as single integrated resources.

Furthermore, the values associated with these integrated states and data values can be communicated back to the debugging interface where they can be displayed within the debugging interface at 122. In this way, the developer is presented with a normalized and dynamic view of the condition of the debugging session. As will be discussed in more detail below, the developer can use this information to make a determination to dynamically cause of effect a switch or change between simulation modes and emulation modes during the debugging session.

Next, the debugging is initiated, where the instructions are executed in either a simulation mode or an emulation mode. The actual execution that occurs with either of the modes is performed by either a simulator or an emulator. In one embodiment, the simulator and emulator are a conventional simulator and emulator, respectively. These conventionally available debugging tools need not be modified and need not be aware of the processing of the method 100. In this way, embodiments of this invention do not need to create any specialized debugging tools. Moreover, conventional debugging tools are easily integrated into the embodiments of this invention.

Initially, as debugging starts within the debugging session, a first mode of debugging will be known based on the attributes that help define or initialize the debugging session. Correspondingly, the instructions and the attributes are passed to either an emulator or a simulator for processing. As debugging proceeds within the emulator or the simulator, data values and states for physical or logical resources will be altered. These states and values are provided as normal output from the emulator or the simulator.

The processing of the method 100 captures these states and values and uses the mappings described above to control the debugging session by maintaining coherence between the values and the states, as depicted at 130. That is, the mappings permit the processing of the method 100 to dynamically switch (e.g., on the fly) from an emulation debugging mode to a simulation debugging mode when it becomes necessary to do so. This is achievable because the mappings permit the state of resources and values of data to be set in the mode that is being transition to. Moreover, the exact instruction being processed within an executing mode will be known when a transition occurs to a different mode. Thus, the entire state and exact next processing instruction can be set within the mode being transitioned to and this can occur dynamically.

According, during the debugging session a switch command can be received by the session at 131. The switch command is communicated to the debugging session through the debugging interface. In some embodiments, this switch command is received manually (from a developer accessing the debugging interface) at 132 in response to a developer detecting within the debugging interface that debugging has reached a processing point where a switch to a different mode (e.g., simulation to emulation or emulation to simulation) is desired. In other embodiments, at 132, the switch command is received via an automated script (or automated instructions) that the developer defined within the attributes of the debugging session and wants to process as a switch mode command upon detection of a certain state, data value, or upon reaching a defined processing point within the instructions. Thus, switching between emulation and simulation modes can be manually achieved or achieved in an automated fashion (e.g., via a script).

When a switch mode command is received during the session, the mapped resource states and data values are set into the new mode and communicated to the simulator or emulator that is the subject of the transition at 140. Next, at 150, the selective instructions which remain to be debugged in the debugging session are transmitted to the emulator or simulator that is the subject of the transition.

Moreover, the original processing simulator or emulator that is being transitioned from receives communication from the processing of the method 100 to cease or become quiescent. This communication occurs before transition occurs or is initialized in the desired simulator or emulator that is the subject of the transition. Accordingly, synchronization and coherence between the two debugging modes and debugging tools are maintained during the same debugging session.

At 160, the simulator or emulator that has control of the debugging processes the selective instructions during the same debugging session. The results of this processing is monitored by the method 100, recorded within the debugging session, and communicated to the debugging interface. Therefore, during the same debugging session the instructions can be dynamically routed or switched from a simulator to an emulator or from an emulator to a simulator.

Embodiments of the method 100 permit instructions to be debugged within a single debugging session with a simulator and an emulator. Processing transitions occur dynamically within the same debugging session. There is no need to manually exit one debugging tool, manually start another desired debugging tool, and manually initialize the desired debugging tool in order to effectuate this transition. Moreover, there is no need to alter any existing emulator or simulator to achieve the benefits of the embodiments of this invention. As a result, firmware and software instructions can be debugged more quickly than what has conventionally achievable.

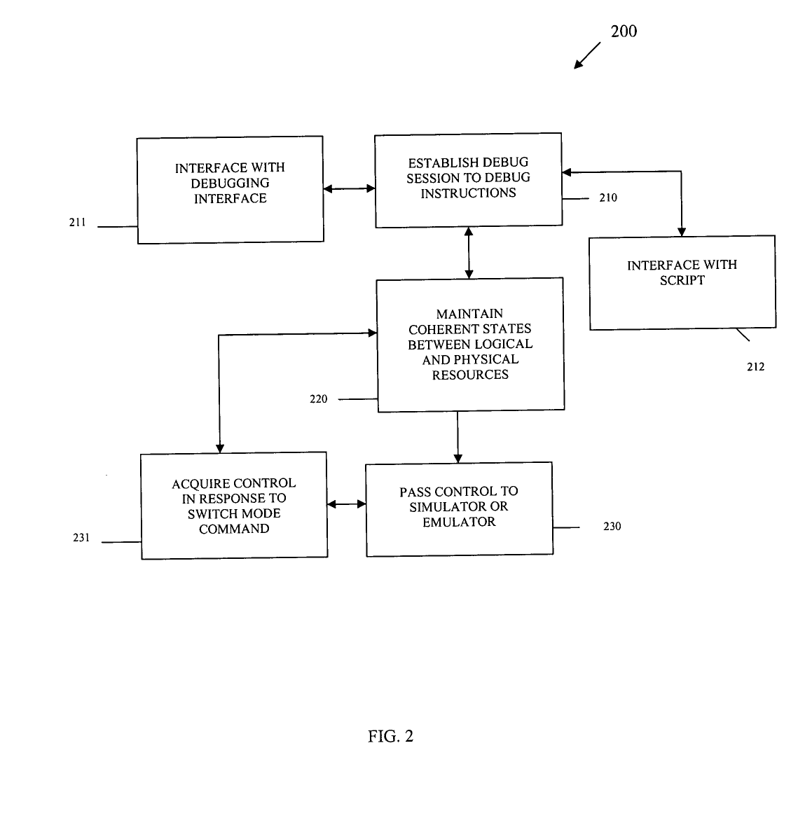

FIG. 2 is a flow diagram of another method 200 to debug instructions. The method is implemented in a computer accessible medium as one or more software applications. In one embodiment, the method 200 is wrapped within a debugging interface, where that debugging interface is designed to present and manage communications between interfaces associated with a simulator and an emulator. Again, the method 200 need not be executing in a computer-accessible medium; however, when the method 200 is executed instructions can be debugged in a novel fashion, according to the processing described below and in other embodiments of the invention.

In manners similar to what has been discussed above with respect to method 100, at 210 a debugging session is established for purposes of debugging instructions associated with firmware or software. In one embodiment, at 211, this session is monitored by, established with, and receives commands from, a debugging interface. In another embodiment, at 212, the session receives commands from a script. That script can originate from the debugging interface or can be independent from the debugging interface.

The debugging session is initialized in manners that are conventionally used and in manners that are described above with respect to method 100. In addition, to initialization that may conventionally occur, the processing of the method 200 establishes and maintains a mapping between logical and physical resources that are consumed by the instructions when they are processed during the debugging session.

Next, the instructions are submitted to a simulator or emulator for processing. Selection of a simulator or emulator is based on the initialized attributes of settings associated with the debugging session, or can be affirmatively selected within the debugging session by the developer via the debugging interface or indirectly via a script's logic. During the processing, coherent states between the logical and physical resources are maintained at 220. Coherency and synchronization is achievable because of the mappings and the debugging session's knowledge as to what currently active debugging tool (e.g., simulator or emulator) is currently processing what specific instruction of the instructions associated with the debugging session. This information permits the processing of the method 200 to temporarily suspend or halt processing in one debugging tool (using commands recognized and understood by that debugging tool, which perform a processing halt), initialize states and any data values in a desired debugging tool (using commands recognized and understood by the desired debugging tool for setting a debug environment), and provide selective instructions from the remaining unprocessed instructions to the desired debugging tool for processing. This transition occurs in an automated or seamless fashion and without manual intervention being required on the part of the developer.

Accordingly, when the processing of the method 200 receives an indication from the debugging session that a debugging interface or an automated script desires to switch the debugging from one debugging tool to another desired debugging tool, control is acquired from the current processing debugging tool at 231. This can be achieved by sending the current processing debugging tool a command that its interface understands, which instructs the current processing debugging tool to pause or cease processing the instructions being debugged. Once confirmation is received from the current processing debugging tool that it has ceased processing, then, at 230, the debugging session control can be passed to the desired debugging tool.

Control is passed between a current processing debugging tool to a desired debugging tool, by initializing or setting the desired debugging tool with the state mappings associated with the resources and their data values. Next, the instruction which had not yet been processed in the previous processing debugging tool and the remaining instructions associated with the instructions being debugged are provided to the desired debugging tool. Finally, the desired debugging tool is instructed to begin processing. In this way, the transition between a current processing debugging tool and a desired debugging tool is automated requiring no interaction from a developer that is monitoring and directing the debugging session. Moreover, transitions occur within a single debugging session.

The debugging tools can be existing and conventionally available simulators and emulators. The debugging session can dynamically switch or change from a simulation mode to an emulation mode or from an emulation mode to a simulation mode. There is no limit on the number of transitions that can occur within the debugging session. The coherency of the session between the two different debugging modes and tools is automatically and dynamically maintained during a single debugging session. This has not been conventionally achievable, and as a result conventional techniques require more development resources and time in order to debug instructions efficiently.

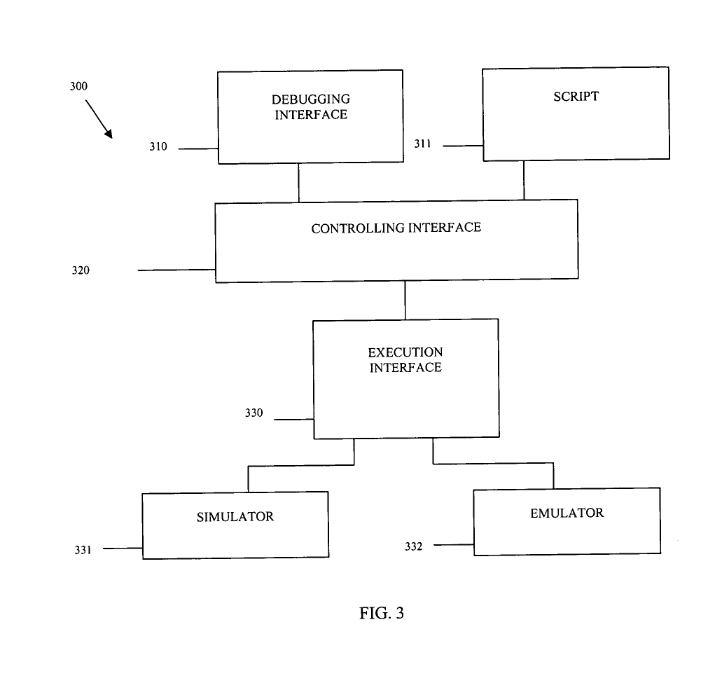

FIG. 3 is a diagram of a debugging system 300. The debugging system 300 is implemented in and accessible from a computer readable or accessible medium. In one embodiment, the debugging system 300 is implemented as one of more software applications accessible and operational within a computer-accessible or readable medium.

The debugging system 300 includes a debugging interface 310, a controlling interface 320, and a debugging execution interface 330. In some embodiments, each of the interfaces 310-330 includes an Application Programming Interface (API) which includes a variety of commands or operations that can be used to perform debugging operations. The debugging interface 310 communicates with the controlling interface 320, and the controlling interface 320 communicates with the debugging execution interface 330.

The debugging interface 310 can also communicate with automated scripts 311 or a developer. The debugging interface 310 is used for initially identifying instructions that are to be debugged and for establishing a debugging session for the instructions. Moreover, the debugging interface 310 can be used for setting the initial debugging attributes associated with the debugging environment. Once the attributes and the session are established the instructions are ready to be debugged within the debugging system 300.

The controlling interface 320 interacts with the debugging interface and the debugging execution interface 330. Interactions with the debugging interface 310 are made for communicating states and values for physical and logical resources that are consumed during the debugging session. These states and values are presented within the debugging interface 310 for consumption by a developer or a script 311 that also interacts with the debugging interface 310. Moreover, the controlling interface 320 debugging interface 310 interactions for receiving commands from the developer or script 311 that communicates with the debugging interface 310. The debugging interface 310 also communicates the attributes of the debugging session and the instructions to the controlling interface 320.

The controlling interface 320 maintains coherency between the states and values of the physical and logical resources during the debugging session. Coherency is maintained by maintaining a mapping of the physical and logical resources. The physical resources are related to processor, bus, and memory resources of a processor, these resources are used when performing emulation during the debugging session. Conversely, the logical resources relate to software representations of the physical resources, these logical resources are used when performing simulation during the debugging session. The controlling interface 320 presents a single normalized and mapped view of the logical and physical resources to the debugging interface 310. This permits a debugger or an automated script 311 to readily discern the states and values of both logical and physical resources as they change when the debugging session progresses. Progression occurs as the instructions are processed by the debugging execution interface 330.

The debugging execution interface 330 debugs or processes the instructions during the debugging session. In one embodiment, the debugging execution interface 330 includes two distinct debugging tools, namely a simulator 331 and an emulator 332. These debugging tools 331-332 can be conventional debugging tools which include their own independent debugging commands and features. These debugging tools 331-332 need not be aware of the controlling interface 320 or the debugging interface 310. Communications expected by these debugging tools 331-332 are made in manners normally expected by their interfaces. Moreover, results produced by these debugging tools are communicated by the debugging tools 331-332 in manners that they would expect. The controlling interface 320 and the debugging interface 310 provide proper translation between native commands to and from the debugging tools 331-332 in order to achieve the embodiments of this invention.

During operation of the debugging system 300, the debugging session can be processing a number of the instructions within a simulation mode or an emulation mode. In the simulation mode, the debugging execution interface processes instructions with a simulator 331. In the emulation mode, the debugging execution interface processes instructions with an emulator 332.

Assume, by way of example only, that initially, the debugging session is proceeding to debug the instructions within an emulation mode using an emulator 332 associated with the debugging execution interface 330. Next, assume further that either a developer that is inspecting the states and data values of the mapped resources issues a switch mode command, or that an automated script 311 detects a state, a particular segment of the instructions, or a data value that warrants the issuing of a switch mode command based on the script's 311 processing logic. This switch mode command is communicated from the debugging interface 310 to the controlling interface 320. The controlling interface 320 than halts or suspends processing within the emulator 332 by issuing the proper halt command that is understood by the debugging execution interface 330 or the emulator 332. Next, the emulator 332 ceases processing on the instructions and confirms the same with the debugging execution interface 320, which is then communicated to the controlling interface 320. The controlling interface 320 then uses the mapped states and values to set the proper states and values for the logical resources of a simulator 331 via the debugging execution interface 330 and passes the next unprocessed instruction within the set of instructions being processed to the simulator 331. The simulator 331 is then started at that next instruction with the debugging session and the debug process continues seamlessly.

In a like manner, consider by way of example, that the debugging session is currently processing instructions within a simulation mode using a simulator 331. A developer or an automated script 311 issues a switch mode command, indicating that there is a need to switch from the simulator 331 to an emulator 332. The controlling interface 320 receives this command and halts the simulator 331. Next, the controlling interface interacts with the debugging execution interface 330 to set the proper states and values for the physical resources and provides the emulator 332 with the next unprocessed instruction included within the set of instructions being debugged. The emulator 332 is then started with the next unprocessed instruction. In this way, the debugging session is dynamically changed from a simulation mode to an emulation mode.

As has been discussed above, the number of dynamic transitions from a simulation mode to an emulation mode and from an emulation mode to a simulation mode are limitless during a single debugging session. Once more, there is no need to terminate one debugging session and manually initiate and define a new debugging session when transitions are desired. In this way, with the teachings of the embodiments of this invention, a single debugging session accommodates the debugging needs of a developer. Conventionally, a developer may need to use and manually manage a plurality of debugging sessions in order to effectively debug instructions.

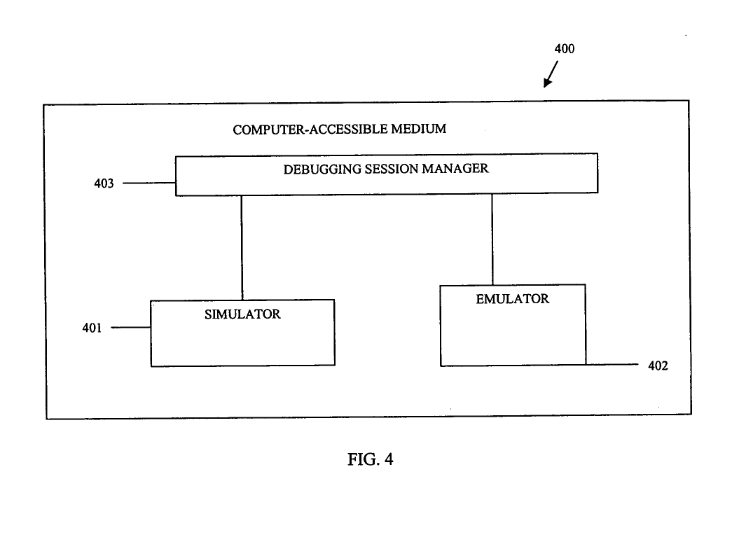

FIG. 4 is a diagram of one debugging apparatus 400. The debugging apparatus 400 is implemented in a computer-accessible or readable medium. The debugging apparatus is implemented as software applications that when processed permits a single debugging session to dynamically change between simulation and emulation modes of operation.

The debugging apparatus 400 includes a simulator 401, an emulator 402, and a debugging session manager 403. The simulator 401 processes instructions during a debugging session when the debugging session is in a simulation mode of operation. The emulator 402 processes instructions during a debugging session when the debugging session is in an emulation mode of operation.

The debugging session manager 403 maintains mappings and coherency between the two modes of operation during the debugging session. This is achieved by mapping the logical resources associated with the simulator 401 to and with the physical resources associated with the emulator 402. The mappings also include the states and data values associated with the mapped resources. Some resources may not map directly and are thus maintained individually. That is, the simulator 401 may include advanced features associated with pure logical resources for which there is no corresponding physical resource. Thus, the debugging session manager 403 maintains mapped resources and any resources that are uniquely associated with only one of the two modes of operation.

During a single debugging session, the debugging session manager 403 can interact with a debugging interface for purposes of communicating the mapped states and data values and any unique states and data values associated with only one mode of operation. The debugging session manager 403 also processes switch or change mode commands, which indicate that there is a need to change control from either the simulator 401 while the current processing mode is in a simulation mode of operation to an emulator 402 for purposes of processing in an emulation mode of operation, or vice versa: move from an emulation mode (via the emulator 402) to a simulation mode (via the simulator 401) of operation.

Control during the debugging session is changed when the debugging session manager 403 halts one of the debugging tools (simulator 401 or emulator 402), sets the initial state and data values of resources in a desired debugging tool, provides the next instruction for processing in the desired debugging tool, and initiates the desired debugging tool to begin processing on the next instruction for processing. The debugging session manger 403 achieves change of control between the simulator 401 and the emulator 402 dynamically and without any need to change, terminate, or manually configure any new debugging session.

The above description is illustrative, and not restrictive. Many other embodiments will be apparent to those of skill in the art upon reviewing the above description. The scope of embodiments of the invention should therefore be determined with reference to the appended claims, along with the full scope of equivalents to which such claims are entitled.

The Abstract is provided to comply with 37 C.F.R. §1.72(b) requiring an Abstract that will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method, comprising:
interacting with a debugging interface for receiving instructions to debug during a debugging session;
maintaining coherence between a simulation mode and an emulation mode; and
switching between the emulation mode and the simulation mode during the debugging session.

2. The method of claim 1 further comprising debugging a number of the instructions by a simulator while in the simulation mode.

3. The method of claim 1 further comprising debugging a number of the instructions by an emulator while in the emulation mode.

4. The method of claim 1 wherein interacting further includes displaying, by the debugging interface, a current state of a resource associated with the instructions during the debugging session.

5. The method of claim 1 wherein interacting further includes receiving, by the debugging interface, manual commands to debug the instructions during the debugging session.

6. The method of claim 1 wherein interacting further includes receiving, by the debugging interface, script commands to debug the instructions during the debugging session.

7. The method of claim 6 wherein interacting further includes receiving by the debugging interface, a switch command to process the switching between the emulation mode and the simulation mode.

8. A method, comprising:
establishing a debugging session to debug instructions;
maintaining coherent states between logical and physical resources that are used to debug the instructions during the debugging session; and
passing control of the debugging session between a simulator that manages the logical resources and an emulator that manages the physical resources during the debugging session.

9. The method of claim 8 further comprising interfacing with a debugging interface that supplies a switch mode command, which drives the passing of control.

10. The method of claim 9 further comprising transmitting the coherent states to the debugging interface.

11. The method of claim 8 further comprising interfacing with a script that supplies a switch mode command, which drives the passing of control.

12. The method of claim 8 further comprising:
acquiring control from the simulator when control is with the simulator in response to receiving a switch mode command; and
passing control to the emulator.

13. The method of claim 8 further comprising:
acquiring control from the emulator when control is with the emulator in response to receiving a switch mode command; and
passing control to the simulator.

14. The method of claim 8 further comprising, receiving the instructions from a debugging interface.

15. A system, comprising:
a debugging interface to receive instructions that are to be debugged during a debugging session;
a controlling interface to maintain coherence between a simulation mode and an emulation mode associated with the debugging session; and
a debugging execution interface to debug a number of the instructions while the debugging session is in the simulation mode or the emulation mode;
wherein the debugging interface communicates with the controlling interface and the controlling interface communicates with the debugging execution interface.

16. The system of claim 15 wherein the debugging execution interface further includes:
a simulator to process a number of the instructions while in the simulation mode; and
an emulator to process a number of the instructions while in the emulation mode.

17. The system of claim 15 wherein the debugging interface supplies the instructions to the controlling interface.

18. The system of claim 15 wherein the debugging interface supplies a switch mode command to the controlling interface and in response to the switch mode command the controlling interface sets at least one of the simulation mode and emulation mode and switches control of the debugging session by communicating with the debugging execution interface.

19. A machine accessible medium having associated data, which when accessed, carries out in a machine the method of:
establishing a debugging session to debug instructions;
maintaining coherent states between logical and physical resources that are used to debug the instructions during the debugging session; and
changing control between simulation modes associated with the logical resources and emulation modes associated with the physical resources during the debugging session.

20. The medium of claim 19 wherein the debugging session is established and driven by a debugging interface.

21. The medium of claim 19 wherein control is changed between a simulator for the simulation modes and an emulator for the emulation modes.

22. An apparatus in a computer accessible medium comprising:
a simulator;
an emulator; and
a debugging session manager, wherein the debugging session manager manages a debugging session to debug instructions, and wherein during the debugging session a number of the instructions are selectively processed by the emulator and a number of the instructions are selectively processed by the simulator.

23. The apparatus of claim 22 wherein the debugging session manager interacts with a debugging interface to receive the debug instructions and establish the debugging session.

24. The apparatus of claim 23 wherein the debugging session manager selectively determines which of the instructions that the simulator and emulator process based on commands received from the debugging interface.

25. The apparatus of claim 23, wherein the debug session manager passes control between the simulator and the emulator as many times as is requested during the debug session.
